(19) United States
(12) Patent Application Publication
(10) Pub. No.: US 2024/0409369 A1
(43) Pub. Date: Dec. 12, 2024

(54) TOP OF CAR HANDRAIL VIRTUAL SAFETY NET

(71) Applicant: OTIS ELEVATOR COMPANY, Farmington, CT (US)

(72) Inventors: Randy Roberts, Hebron, CT (US); Johanna Whitwell, Hartford, CT (US); Craig Drew Bogli, Avon, CT (US)

(21) Appl. No.: 18/333,250

(22) Filed: Jun. 12, 2023

(51) Int. Cl. B66B 5/00; B66B 5/02

(52) U.S. Cl. CPC B66B 5/0056; B66B 5/0081; B66B 5/025

(57) ABSTRACT

An elevator system, having: a hoistway, a pit and an elevator car; a sensor assembly, wherein the sensors are distributed about the elevator car and configured to form a virtual safety net (VSN) around at least a portion of a first area that is exterior to the elevator car; and an elevator safety, wherein the sensor assembly is configured to: monitor for a breach of the VSN by an object that is potentially human; and upon detecting the breach of the VSN by the object, opening the elevator safety chain and stoping the elevator car.

### BACKGROUND

The embodiments herein relate to elevator safety systems and more particularly to a top of car handrail virtual safety net (VSN).

Potential hazard conditions may exist in a hoistway because of a failure to take and maintain control of a car or counterweight. As a result, human sensing devices that open the elevator safety chain (e.g., cutting drive power and engaging the machine brake) may be installed in the hoistway and on top of the car in order to foolproof the system.

A cost-effective ability to detect mechanics leaning over the top of car handrail is desired. A challenge for such systems is the potential existence of top of car components located in a field of view of utilized sensors. In addition, a position of a mechanic while working over the handrail may obstruct the sensor field of view.

### SUMMARY

Disclosed is an elevator system, including: a hoistway, a pit and an elevator car; a sensor assembly, wherein the sensors are distributed about the elevator car and configured to form a virtual safety net (VSN) around at least a portion of a first area that is exterior to the elevator car; and an elevator safety chain, wherein the sensor assembly is configured to: monitor for a breach of the VSN by an object that is potentially human; and upon detecting the breach of the VSN by the object, opening the elevator safety chain and stopping the elevator car.

In addition to one or more aspects of the system, or an alternate, the sensor assembly is mounted to the elevator car, which includes a top and the first area is the top of the elevator car.

In addition to one or more aspects of the system, or an alternate, the system includes a handrail system located at the top of the elevator car, wherein the VSN extends about the handrail system and vertically above the handrail system by a predetermined distance to define a set of virtual sensing planes; and adjacent ones of the virtual sensing planes are perpendicular to each other.

In addition to one or more aspects of the system, or an alternate, the handrail system has four corners; one of the sensors is located at each of the corners of the handrail system; and each of the sensors provides one of the virtual sensing planes.

In addition to one or more aspects of the system, or an alternate, the sensors are motion, depth or range sensors.

In addition to one or more aspects of the system, or an alternate, the sensors include one of a LIDAR, RADAR, or a camera.

In addition to one or more aspects of the system, or an alternate, the sensors include millimeter wave RADAR.

In addition to one or more aspects of the system, or an alternate, the sensors include an RGBD camera.

In addition to one or more aspects of the system, or an alternate the VSN defines a safety area that surrounded by the VSN; the sensor assembly is configured to monitor when the object is within the safety area, and upon detecting the object is within the safety area, the elevator safety chain is opened by the sensor assembly to stop the elevator car.

In addition to one or more aspects of the system, or an alternate, the sensor assembly is configured to determine that sensors capture that the object, breaches the VSN or is within the safety area for a predetermined minimum number of sensor scans before opening the elevator safety chain, by the sensor assembly, to stop the elevator car.

Further disclosed is a method of controlling an elevator system that includes a hoistway, a pit and an elevator car, the method including: forming a virtual safety net (VSN) by a sensor assembly, wherein the sensors are distributed about the elevator car and form the VSN around at least a portion of a first area that is exterior to the elevator car; monitoring, by the sensor assembly for a breach of the VSN by an object that is potentially human; opening the elevator safety chain to stop the elevator car upon the sensor assembly detecting the object breaching the VSN.

In addition to one or more aspects of the method, or an alternate, the sensor assembly is mounted to the elevator car, which includes a top and the first area is the top of the elevator car.

In addition to one or more aspects of the method, or an alternate, the VSN extends about the top of a handrail system located at the top of the elevator car and vertically above the handrail system by a predetermined distance to define a set of virtual sensing planes; and the method includes: orienting adjacent ones of the virtual sensing planes to be perpendicular to each other.

In addition to one or more aspects of the method, or an alternate, the handrail system has four corners; and the method includes: positioning one of the sensors at each of the corners of the handrail system so that each of the sensors provides one of the virtual sensing planes.

In addition to one or more aspects of the method, or an alternate, the sensors are motion, depth or range sensors.

In addition to one or more aspects of the method, or an alternate, the sensors include one of a LIDAR, RADAR, or a camera.

In addition to one or more aspects of the method, or an alternate, the sensors include millimeter wave RADAR.

In addition to one or more aspects of the method, or an alternate, the sensors include an RGBD camera.

In addition to one or more aspects of the method, or an alternate, the method includes defining, by the sensor assembly, a safety area that is surrounded by the VSN; monitoring, by the sensor assembly, when the object is within the safety area; and upon detecting by the sensor assembly the object is within the safety area, opening the elevator safety chain, by the sensor assembly, to stop the elevator car.

In addition to one or more aspects of the method, or an alternate, the method includes: opening the elevator safety chain, by the sensor assembly, to stop the elevator car after determining, by the sensor assembly, that the sensors capture the object, breaching the VSN or being within the safety area for a predetermined minimum number of sensor scans. The foregoing features and elements may be combined in various combinations without exclusivity, unless expressly indicated otherwise.

These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows additional aspects of the elevator system, configured with a plurality of motion sensors for detecting an object, is on top of the elevator car;

FIG. 3 shows further aspects of the elevator system, configured with the plurality of motion sensors for detecting an object is on top of the elevator car;

FIG. 4 shows a representative view of the safety net, where the shaded area is the detection region;

FIG. 5 is a flowchart for a process executed by the elevator system of utilizing a virtual safety net for detecting an object on top of the elevator car and responsively controlling the elevator car; and

FIG. 6 is a flowchart generally showing the process executed by the elevator system of utilizing the virtual safety net for detecting the object on top of the elevator car and responsively controlling the elevator car.

### DETAILED DESCRIPTION

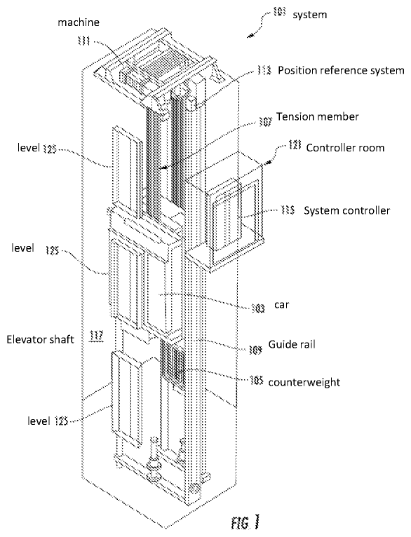

FIG. 1 is a perspective view of an elevator system 101 including an elevator car 103, a counterweight 105, a tension member 107, a guide rail 109, a machine 111 (alternatively referred to as a drive), a position reference system 113, and a system controller 115, which may be utilized to control normal elevator car operations and active safety functions. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The system controller 115 is located, as shown, in a controller room 121 of the elevator shaft 117 and is configured to control the operation of the elevator system 101, and particularly the elevator car 103. It is to be appreciated that the controller 115 need not be in the controller room 121 by may be in the hoistway or other location in the elevator system. For example, the system controller 115 may provide drive signals to the machine 111 to control the acceleration, deceleration, leveling, stopping, etc. of the elevator car 103. The system controller 115 may also be configured to receive position signals from the position reference system 113 or any other desired position reference device. When moving up or down within the elevator shaft 117 along guide rail 109, the elevator car 103 may stop at one or more landings 125 as controlled by the system controller 115. Although shown in a controller room 121, those of skill in the art will appreciate that the system controller 115 can be located and/or configured in other locations or positions within the elevator system 101. In one embodiment, the system controller 115 may be located remotely or in a distributed computing network (e.g., cloud computing architecture). The system controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

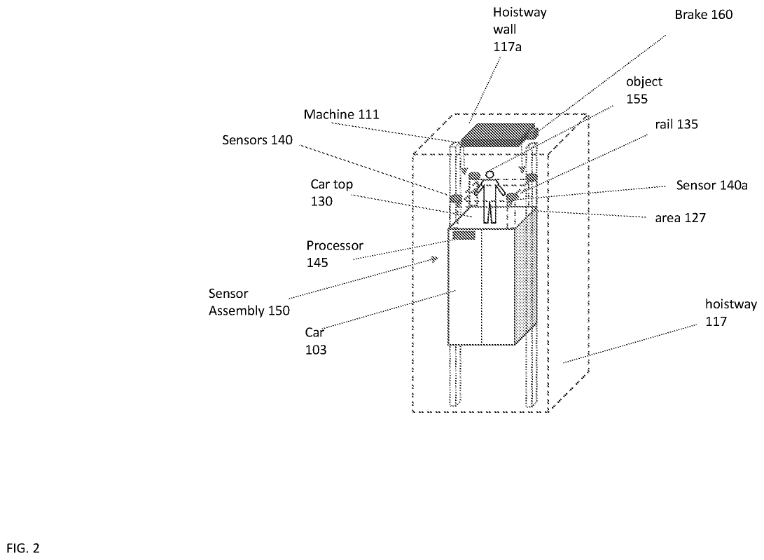

As shown in FIG. 2, the elevator car 10, in the hoistway 117, including a rear wall 117a, has a sensor assembly 150, which may include one or more sensors 140 and may further include or communicate with a processor 145, and which may capture and process images 142. The sensor assembly 150 has memory and communication circuitry so that it communicates, e.g., with the system controller 115 via an intelligent safety control system. The sensor assembly 150 may include a link to a controllable relay that can be opened to open the safety chain. The connection to the safety chain could be via an electrical relay or via an intelligent safety control system via a communicated message to the elevator safety system, including the system controller 115.

A car top 130 may be equipped with a handrail system 135 and the sensors 140, including a first sensor 140a, disposed on the handrail system 135. It is to be appreciated that other mounting configurations in the elevator system are within the scope of the disclosure. The sensors 140, which may be range or depth sensors, may be motion sensors. The sensors 140 may be LIDAR, RADAR such as millimeter wave RADAR, or a camera such as an RGBD camera.

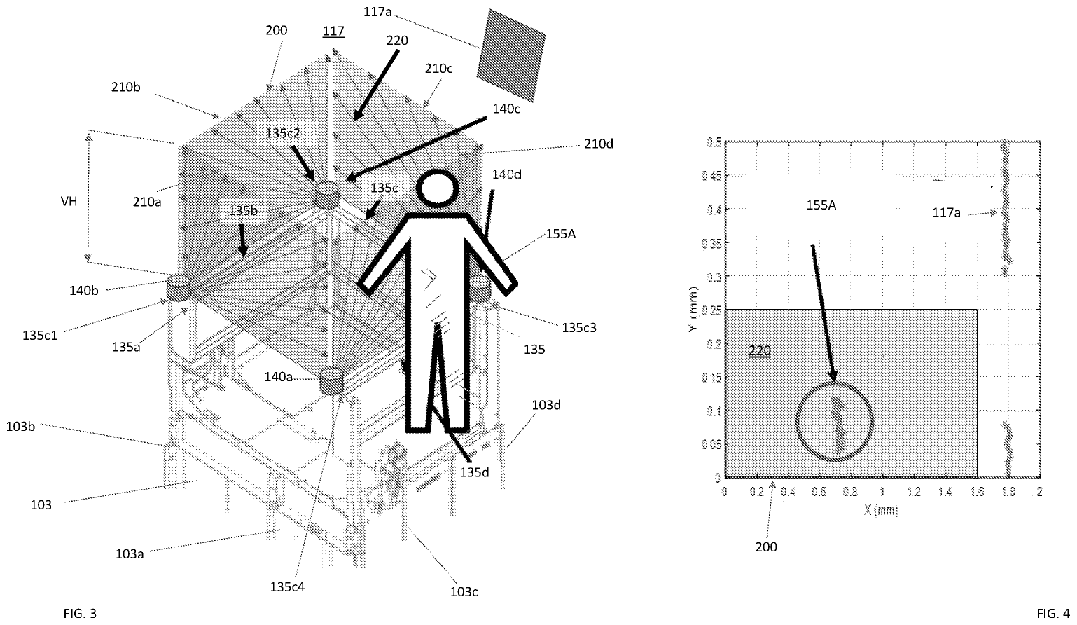

The sensor assembly 150 is configured to sense when an object 155 that is of concern, because of its size and movement that are indicative of it being potentially human, is above the elevator car 103 and extending beyond the elevator car, e.g., into the hoistway 117, and open the elevator safety chain. This results in cutting drive power from the machine 111 and engaging the machine brake 160. The sensor assembly 150 may alternatively be mounted elsewhere on the elevator car, such as the bottom, or the elevator system such as within the hoistway, the pit, including the pit ladder. FIG. 3 shows a configuration of the handrail sensors 140, which are LIDAR sensors, configured to create a virtual safety net (VSN) 200, or virtual safety fence, that extends above the rails 135. Four LIDAR sensors 140a-140d are positioned at respective ones of four corners 135c1-135c4 of the handrail system 135 on the top 130 of the car 103.

Each of the sensors 140 creates a two dimensional (2D) virtual sensing plane 210a-210d, otherwise referred to as a virtual planar fence section of the VSN 200, above an adjacent length of the handrail system 135. That is, a four sided elevator car 103, having sides 103a-103d, has the handrail system 135 with four handrail sides 135a-135d. Above the handrail system 135, the four sensors 140a-140d create the set of four virtual sensing planes 210a-210d, one along each of the handrail sides 135a-135d. Adjacent ones of the sensing planes 210a-210d are perpendicular to each other. Thus, the sensing planes 210a-210d of the VSN 200 are oriented and aligned so that, together, they form the VSN 200 over the handrail system 135.

The VSN 200 defines a safety area 220 that extends around the handrail sides 135a-135d and projects a predetermined vertical height VH, about one meter, above the handrail system 135. This configuration ensures adequate detection of any part of a person, such as a mechanic's arm, protruding into it.

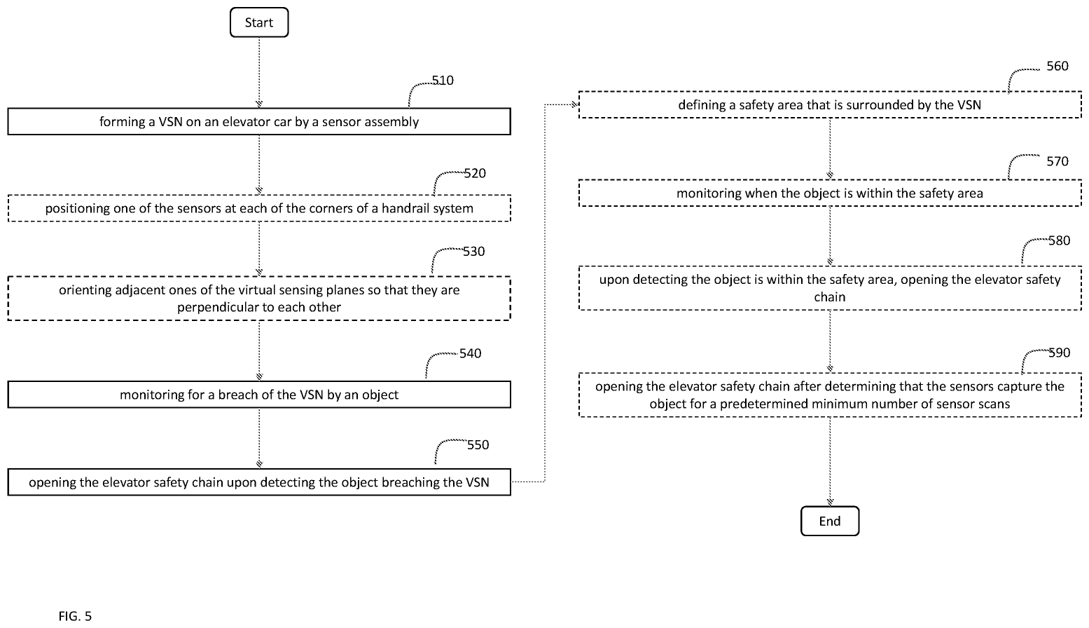

FIG. 4 shows a representative view of the VSN 200. The safety area 220 extends above and between each length of the handrail sides 135a-135d (FIG. 3). With the VSN 200, the sensor assembly 150 (FIG. 3) can detect an arm 155a of a mechanic 155 that is extended over the handrail system 135 (FIG. 3). Additionally, beyond the VSN 200, the sensor assembly 140 may sense one or more walls, such as a rear wall 117A, of the elevator shaft 117. Human detection is triggered when the sensor assembly 150 determines that enough points along one or more of the sensing planes 210a-210d of the VSN 200 (FIG. 3) senses an object, such as an arm 155A, extending through the VSN 200 and into the safety area 220 during a minimum number of sensor scans, e.g., that is greater than a threshold, to avoid false positives. Upon detecting an object 155 is above the elevator car 103 and through the VSN 200, e.g., into the hoistway or into the safety area 220, the elevator safety chain is opened. This results in cutting drive power from the machine 111 and engaging the machine brake 160.

The sensors 140 typically scan their respective areas in their field of views at an update rate (scans/sec). FIG. 4 shows what a single scan would produce as a “point cloud” of sensed range values. Detection of humans can be determined by looking at individual scans and the points that show up in them as described above, but also determining their persistence over a range of scans in time. Thus, both image processing (as described above) and video processing (with multiple scanned frames of video) can be used for robust human detection and are thus within the scope of the disclosure.

FIG. 5 is a flowchart for a process executed by the elevator system 101 of utilizing the VSN 200 for detecting the object 155 on the top 130 of the elevator car 103 and responsively controlling the elevator car 103, e.g., to stop.

As shown in block 510, the method includes forming the VSN 200 by a sensor assembly 150, which includes sensors 140 and processor 145 that capture and process images 142, mounted to the elevator car 103, where the sensors 140 are mounted around at least a portion of a first area 127 that is exterior to the elevator car 103. As shown in block 520 forming the VSN (block 510) may include positioning one of the sensors 140 at each of the corners 134c1-135c4 of the handrail system 135 on the top 130 of the elevator car 103. As shown in block 530 the method may include orienting adjacent ones of the virtual sensing planes 210a-210d formed by the sensors 140, that together form the VSN 200, so that they are perpendicular to each other. An alternate embodiment would be for the sensors to be located in the center of the rail sections and use a 180 degree FOV (field of view) to scan around them to cover the VSN areas 135.

As shown in block 540, the method includes monitoring, by the sensor assembly 150 of the elevator car 103 for a breach of the VSN 200 by an object 155. As shown in block 550, the method includes opening an elevator safety chain, to control the drive 111 and the machine brake 160 to stop the elevator car 103, upon the sensor assembly 150 detecting the object 150, breaching the VSN 200.

As shown in block 560, the method may include defining, by the sensor assembly 150, a safety area 220 that is surrounded by the VSN 200. As shown in block 570, the method may include monitoring, by the sensor assembly 150, when the object 155 is within the safety area 210. As shown in block 580, upon the sensor assembly 150 detecting the object 155 is within the safety area 210, the method may include opening the elevator safety chain the sensor assembly 150 to stop the elevator car 103. As shown in block 590, the method may include opening the elevator safety chain to stop the elevator car 103 after determining, by the sensor assembly 150, that the object 155, is breaching the VSN 200 or is within the safety area 210 for a predetermined minimum number of sensor scans.

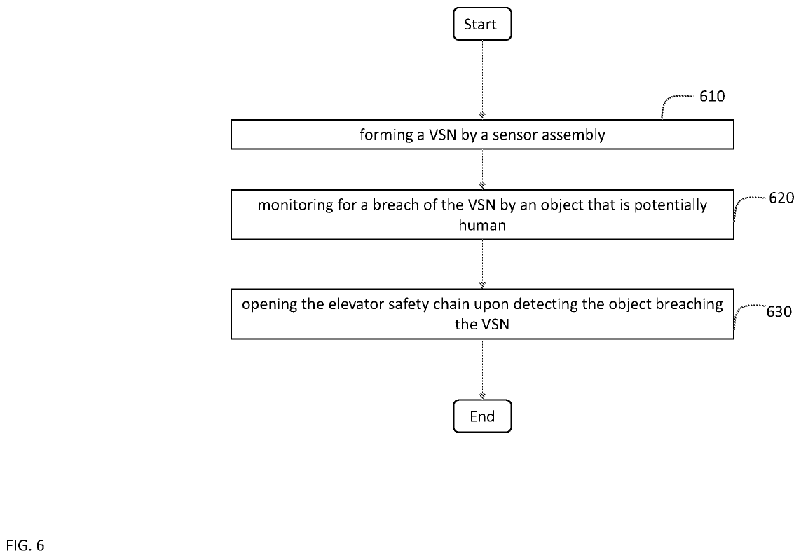

FIG. 6 is a flowchart generally showing the process executed by the elevator system 101 of utilizing the VSN 200 for detecting the object 155 on the top 130 of the elevator car 103 and responsively controlling the elevator car 103, e.g., to stop. As shown in block 610, the method includes forming the VSN 200 by a sensor assembly 150, which includes sensors 140 and processor 145 that capture and process images 142, mounted to the elevator car 103, where the sensors 140 are mounted around at least a portion of a first area 127 that is exterior to the elevator car 103. As shown in block 620, the method includes monitoring, by the car sensor assembly 150 of the elevator car 103 that is operationally coupled to the sensors 140, for a breach of the VSN 200 by an object 155. As shown in block 630, the method includes opening an elevator safety chain, to control the drive 111 and the machine brake 160 to stop the elevator car 103, upon the sensor assembly 150 detecting the object 155, breaching the VSN 200.

The disclosed system is relatively easy to install and adjust, requiring minimum service and maintenance. It is capable of providing high detection performance with low false positive and negative outcomes. It is a relatively simple, low-cost effect system that detects mechanics leaning over the top of car handrail, and it is robust and can be applied to a wide range of top of car layouts, reducing concern about obstacles or blocked vantage points.

In the disclosed embodiment, the sensors 140 are distributed around a first area 127 that is exterior to the elevator car 103, which is the top 130 of the elevator car 103. The disclosed detection system and process can be applied to other areas of the elevator system 101, such as the pit area, ladder, etc.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz-typically in the 769-935 MHz, 315 Mhz and the 468 Mhz frequency range. This spectrum band below 1 Ghz is particularly useful for RF IOT (internet of things) applications. The Internet of things (IoT) describes the network of physical objects-“things”-that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is available means a commonly of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system, comprising:
a hoistway, a pit and an elevator car;
a sensor assembly, wherein the sensors are distributed about the elevator car and configured to form a virtual safety net (VSN) around at least a portion of a first area that is exterior to the elevator car; and
an elevator safety chain,
wherein the sensor assembly is configured to:
monitor for a breach of the VSN by an object that is potentially human; and
upon detecting the breach of the VSN by the object, opening the elevator safety chain and stopping the elevator car.

2. The system of claim 1, wherein the sensor assembly is mounted to the elevator car, which includes a top and the first area is the top of the elevator car.

3. The system of claim 2, including:
a handrail system located at the top of the elevator car,
wherein the VSN extends about the handrail system and vertically above the handrail system by a predetermined distance to define a set of virtual sensing planes; and
adjacent ones of the virtual sensing planes are perpendicular to each other.

4. The system of claim 3, wherein:
the handrail system has four corners;
one of the sensors is located at each of the corners of the handrail system; and
each of the sensors provides one of the virtual sensing planes.

5. The system of claim 1, wherein the sensors are motion, depth or range sensors.

6. The system of claim 1, wherein the sensors include one of a LIDAR, RADAR, or a camera.

7. The system of claim 1, wherein the sensors include millimeter wave RADAR.

8. The system of claim 1, wherein the sensors include an RGBD camera.

9. The system of claim 1, wherein:
the VSN defines a safety area that surrounded by the VSN;
the sensor assembly is configured to monitor when the object is within the safety area, and
upon detecting the object is within the safety area, the elevator safety chain is opened by the sensor assembly to stop the elevator car.

10. The system of claim 9, wherein:
the sensor assembly is configured to determine that sensors capture that the object, breaches the VSN or is within the safety area for a predetermined minimum number of sensor scans before opening the elevator safety chain, by the sensor assembly, to stop the elevator car.

11. A method of controlling an elevator system that includes a hoistway, a pit and an elevator car, the method comprising:
forming a virtual safety net (VSN) by a sensor assembly, wherein the sensors are distributed about the elevator car and form the VSN around at least a portion of a first area that is exterior to the elevator car;
monitoring, by the sensor assembly for a breach of the VSN by an object that is potentially human;
opening the elevator safety chain to stop the elevator car upon the sensor assembly detecting the object breaching the VSN.

12. The method of claim 11, wherein the sensor assembly is mounted to the elevator car, which includes a top and the first area is the top of the elevator car.

13. The method of claim 12, wherein:
the VSN extends about the top of a handrail system located at the top of the elevator car and vertically above the handrail system by a predetermined distance to define a set of virtual sensing planes; and
the method includes:
orienting adjacent ones of the virtual sensing planes to be perpendicular to each other.

14. The method of claim 13, wherein:
the handrail system has four corners; and
the method includes:
positioning one of the sensors at each of the corners of the handrail system so that each of the sensors provides one of the virtual sensing planes.

15. The method of claim 11, wherein the sensors are motion, depth or range sensors.

16. The method of claim 11, wherein the sensors include one of a LIDAR, RADAR, or a camera.

17. The method of claim 11, wherein the sensors include millimeter wave RADAR.

18. The method of claim 11, wherein the sensors include an RGBD camera.

19. The method of claim 14, comprising:
defining, by the sensor assembly, a safety area that is surrounded by the VSN;
monitoring, by the sensor assembly, when the object is within the safety area; and
upon detecting by the sensor assembly the object is within the safety area, opening the elevator safety chain, by the sensor assembly, to stop the elevator car.

20. The method of claim 19, comprising:
opening the elevator safety chain, by the sensor assembly, to stop the elevator car after determining, by the sensor assembly, that the sensors capture the object, breaching the VSN or being within the safety area for a predetermined minimum number of sensor scans.
